(19) United States
(12) Patent Application Publication
(10) Pub. No.: US 2025/0272786 A1
(43) Pub. Date: Aug. 28, 2025

(54) IMAGE SUPER-RESOLUTION METHOD, SUPER-RESOLUTION NETWORK PARAMETER ADJUSTMENT METHOD, RELATED APPARATUS, AND MEDIUM

(71) Applicant: Beijing Zitiao Network Technology Co., Ltd., Beijing (CN)

(72) Inventors: Fangyuan KONG, Beijing (CN); Songwei LIU, Beijing (CN); Mingxi LI, Beijing (CN); Yang BAI, Beijing (CN); Fangmin CHEN, Beijing (CN)

(21) Appl. No.: 18/858,296

(22) PCT Filed: May 12, 2023
(86) PCT No.: PCT/CN2023/093880

§ 371 Date: Oct. 18, 2024

(30) Foreign Application Priority Data
May 13, 2022 (CN) 202210524546.1
May 13, 2022 (CN) 202210524706.2

(51) Int. Cl. G06T 3/4053; G06T 3/4046; G06V 10/80

(52) U.S. Cl. CPC G06T 3/4053; G06T 3/4046; G06V 10/806; G06T 2207/20221

(57) ABSTRACT

An image super-resolution method includes: performing feature extraction on an image to be subjected to super-resolution, to obtain a first image feature; processing the first image feature through a feature processing module to obtain a second image feature, where the feature processing module includes: a feature refinement unit that includes at least one set of first convolutional layer and first activation function layer that are connected in series and is configured to process an input feature of the feature processing module; a feature fusion unit configured to perform additive fusion on the input feature of the feature processing module and an output feature of the feature refinement unit; and an attention unit configured to process an output feature of the feature fusion unit to obtain an output feature of the feature processing module; and generating, based on the first image feature and the second image feature, a super-resolution image.

### CROSS-REFERENCE TO RELATED APPLICATIONS

This application is a U.S. National Stage under 35 U.S.C. § 371 of International Application No. PCT/CN2023/093880, as filed on May 12, 2023, which is based on and claims priority to CN Application No. 202210524546.1, filed on May 13, 2022, and CN Application No. 202210524706.2, filed on May 13, 2022. The disclosure of each of these applications are incorporated herein by reference in their entireties.

### TECHNICAL FIELD

The present disclosure relates to the field of image processing technologies, and in particular, to an image super-resolution method, a super-resolution network parameter adjustment method, a related apparatus, and a medium.

### BACKGROUND

Image super-resolution is a technique to restore high-resolution images from low-resolution images. As an image super-resolution service has become a focus in image quality enhancement, image super-resolution is one of research hotspots in the field of image processing.

So far, great progress has been made in a convolutional neural network (CNN)-based image super-resolution model in the field of image super-resolution.

### SUMMARY

According to a first aspect of the present disclosure, an embodiment of the present disclosure provides an image super-resolution method. The method includes:
performing feature extraction on an image to be subjected to super-resolution, to obtain a first image feature; processing the first image feature through a feature processing module to obtain a second image feature, where the feature processing module includes: a feature refinement unit that includes at least one set of first convolutional layer and first activation function layer that are connected in series and is configured to process an input feature of the feature processing module; a feature fusion unit configured to perform additive fusion on the input feature of the feature processing module and an output feature of the feature refinement unit; and an attention unit configured to process an output feature of the feature fusion unit to obtain an output feature of the feature processing module; and
generating, based on the first image feature and the second image feature, a super-resolution image corresponding to the image to be subjected to super-resolution.

In some embodiments, the feature processing module further includes a channel quantity adjustment unit. The channel quantity adjustment unit is configured to adjust the output feature of the feature fusion unit into a feature having a same quantity of channels as the first image feature before the attention unit processes the output feature of the feature fusion unit.

In some embodiments, the processing the first image feature through a feature processing module to obtain a second image feature includes:
processing the first image feature through a plurality of stages of feature processing modules that are connected in series, to obtain the second image feature.

In some embodiments, an activation function at the first activation function layer is a linear rectification function ReLU.

In some embodiments, the channel quantity adjustment unit includes a second convolutional layer, where the second convolutional layer has a convolution kernel size of 1*1.

In some embodiments, the performing feature extraction on an image to be subjected to super-resolution, to obtain a first image feature includes:
convolving, through a third convolutional layer, the image to be subjected to super-resolution, to obtain the first image feature.

In some embodiments, the generating, based on the first image feature and the second image feature, a super-resolution image corresponding to the image to be subjected to super-resolution includes: processing the second image feature through a fourth convolutional layer to obtain a third image feature; performing additive fusion on the first image feature and the third image feature to obtain a fourth image feature; processing the fourth image feature through a fifth convolutional layer to obtain a fifth image feature; up-sampling the fifth image feature to obtain a sixth image feature; and generating, based on the sixth image feature, the super-resolution image corresponding to the image to be subjected to super-resolution.

According to a second aspect, an embodiment of the present disclosure provides a super-resolution network parameter adjustment method. The method includes: separately extracting feature information of a first reconstructed image, feature information of a high-resolution image, and feature information of an up-sampled image through a feature extractor, where the feature extractor includes at least one convolution activation module, the convolution activation module includes a convolutional layer and an activation function, the first reconstructed image is a super-resolution image obtained through reconstruction from a low-resolution image by using a super-resolution network, the high-resolution image and the low-resolution image are training sample images for the super-resolution network, the high-resolution image and the low-resolution image are images of same visual content at different resolutions, the up-sampled image is an image obtained by performing up-sampling on the low-resolution image, and the first reconstructed image, the high-resolution image, and the up-sampled image have a same resolution; performing calculation for a contrastive loss function based on the feature information of the first reconstructed image, the feature information of the high-resolution image, and the feature information of the up-sampled image to obtain a first contrastive loss function value that is based on the first reconstructed image; and adjusting a parameter of the super-resolution network based on the first contrastive loss function value, to perform reconstruction from the low-resolution image through the adjusted super-resolution network to obtain a second reconstructed image, where a second contrastive loss function value that is based on the second reconstructed image is less than the first contrastive loss function value.

In some embodiments, the at least one convolution activation module has a same convolutional layer.

In some embodiments, the at least one convolution activation module is connected in series.

In some embodiments, the up-sampling is bicubic interpolation.

In some embodiments, the contrastive loss function is a ratio of a first difference term to a second difference term, where the first difference term is used for representing a difference between the first reconstructed image and the high-resolution image, and the second difference term is used for representing a difference between the up-sampled image and the high-resolution image.

In some embodiments, the first difference term is an L1 distance between the feature information of the first reconstructed image and the feature information of the high-resolution image; and the second difference term is an L1 distance between the feature information of the up-sampled image and the feature information of the high-resolution image.

In some embodiments, the contrastive loss function is a ratio of a third difference term to a fourth difference term, where the third difference term is used for representing a difference between the first reconstructed image and the high-resolution image, and the fourth difference term is used for representing a difference between the first reconstructed image and the up-sampled image.

In some embodiments, the third difference term is an L1 distance between the feature information of the first reconstructed image and the feature information of the high-resolution image; and the fourth difference term is an L1 distance between the feature information of the first reconstructed image and the feature information of the up-sampled image.

According to a third aspect, an embodiment of the present disclosure provides an image super-resolution apparatus. The apparatus includes:
a feature extraction component configured to perform feature extraction on an image to be subjected to super-resolution, to obtain a first image feature;
a feature processing component configured to process the first image feature through a feature processing module to obtain a second image feature, where the feature processing module includes: a feature refinement unit that includes at least one set of first convolutional layer and first activation function layer that are connected in series and is configured to process an input feature of the feature processing module; a feature fusion unit configured to perform additive fusion on the input feature of the feature processing module and an output feature of the feature refinement unit; and an attention unit configured to process an output feature of the feature fusion unit to obtain an output feature of the feature processing module; and
an image reconstruction component configured to generate, based on the first image feature and the second image feature, a super-resolution image corresponding to the image to be subjected to super-resolution.

In some embodiments, the feature processing module further includes a channel quantity adjustment unit.

The channel quantity adjustment unit is configured to adjust the output feature of the feature fusion unit into a feature having a same quantity of channels as the first image feature before the attention unit processes the output feature of the feature fusion unit.

In some embodiments, the feature processing component 102 is specifically configured to process the first image feature through a plurality of stages of feature processing modules that are connected in series, to obtain the second image feature.

In some embodiments, an activation function at the first activation function layer is a linear rectification function ReLU.

In some embodiments, the channel quantity adjustment unit includes a second convolutional layer.

The second convolutional layer has a convolution kernel size of 1*1.

In some embodiments, the feature extraction component is specifically configured to convolve, through a third convolutional layer, the image to be subjected to super-resolution, to obtain the first image feature.

In some embodiments, the image reconstruction component is specifically configured to: process the second image feature through a fourth convolutional layer to obtain a third image feature; perform additive fusion on the first image feature and the third image feature to obtain a fourth image feature; process the fourth image feature through a fifth convolutional layer to obtain a fifth image feature; up-sample the fifth image feature to obtain a sixth image feature; and generate, based on the sixth image feature, the super-resolution image corresponding to the image to be subjected to super-resolution.

According to a fourth aspect, an embodiment of the present disclosure provides a super-resolution network parameter adjustment apparatus. The apparatus includes: a feature extraction module, a calculation module, and an adjustment module. The feature extraction module is configured to separately extract feature information of a first reconstructed image, feature information of a high-resolution image, and feature information of an up-sampled image through a feature extractor, where the feature extractor includes at least one convolution activation module, the convolution activation module includes a convolutional layer and an activation function, the first reconstructed image is a super-resolution image obtained through reconstruction from a low-resolution image by using a super-resolution network, the high-resolution image and the low-resolution image are training sample images for the super-resolution network, the high-resolution image and the low-resolution image are images of same visual content at different resolutions, the up-sampled image is an image obtained by performing up-sampling on the low-resolution image, and the first reconstructed image, the high-resolution image, and the up-sampled image have a same resolution. The calculation module is configured to perform calculation for a contrastive loss function based on the feature information of the first reconstructed image, the feature information of the high-resolution image, and the feature information of the up-sampled image, which are extracted by the feature extraction module, to obtain a first contrastive loss function value that is based on the first reconstructed image. The adjustment module is configured to adjust a parameter of the super-resolution network based on the first contrastive loss function value obtained by the calculation module, to perform reconstruction from the low-resolution image through the adjusted super-resolution network to obtain a second reconstructed image, where a second contrastive loss function value that is based on the second reconstructed image is less than the first contrastive loss function value.

In some embodiments, the at least one convolution activation module has a same convolutional layer.

In some embodiments, the at least one convolution activation module is connected in series.

In some embodiments, the up-sampling is bicubic interpolation.

In some embodiments, the contrastive loss function is a ratio of a first difference term to a second difference term, where the first difference term is used for representing a difference between the first reconstructed image and the high-resolution image, and the second difference term is used for representing a difference between the up-sampled image and the high-resolution image.

In some embodiments, the first difference term is an L1 distance between the feature information of the first reconstructed image and the feature information of the high-resolution image; and the second difference term is an L1 distance between the feature information of the up-sampled image and the feature information of the high-resolution image.

In some embodiments, the contrastive loss function is a ratio of a third difference term to a fourth difference term, where the third difference term is used for representing a difference between the first reconstructed image and the high-resolution image, and the fourth difference term is used for representing a difference between the first reconstructed image and the up-sampled image.

In some embodiments, the third difference term is an L1 distance between the feature information of the first reconstructed image and the feature information of the high-resolution image; and the fourth difference term is an L1 distance between the feature information of the first reconstructed image and the feature information of the up-sampled image.

According to a fifth aspect, an embodiment of the present disclosure provides an electronic device. The electronic device includes: a memory and a processor, where the memory is configured to store a computer program; and the processor is configured to call the computer program, to cause the electronic device to implement the image super-resolution method described in any one of the above embodiments and/or the super-resolution network parameter adjustment method described in any one of the above embodiments.

According to a sixth aspect, an embodiment of the present disclosure provides a computer-readable storage medium. When a computer program is executed by a computing device, the computing device implements the image super-resolution method described in any one of the above embodiments and/or the super-resolution network parameter adjustment method described in any one of the above embodiments.

According to a seventh aspect, an embodiment of the present disclosure provides a computer program product which, when run on a computer, causes the computer to implement the image super-resolution method described in any one of the above embodiments and/or the super-resolution network parameter adjustment method described in any one of the above embodiments.

According to an eighth aspect, an embodiment of the present disclosure provides a chip including a processor and a communication interface. The communication interface is coupled to the processor. The processor is configured to run program instructions to implement the super-resolution network parameter adjustment method described in the second aspect.

### BRIEF DESCRIPTION OF THE DRAWINGS

The accompanying drawings herein, which are incorporated into and form a part of the description, illustrate the embodiments in line with the present disclosure and are used in conjunction with the description to explain the principles of the present disclosure.

In order to more clearly illustrate the technical solutions in the embodiments of the present disclosure or in the related art, the accompanying drawings for describing the embodiments or the related art will be briefly described below. Apparently, those of ordinary skill in the art may still derive other drawings from these accompanying drawings without creative efforts.

FIG. 1 is a flowchart of an image super-resolution method according to some embodiments of the present disclosure;

FIG. 2 is a schematic diagram of a structure of a feature processing module according to some embodiments of the present disclosure;

FIG. 3 is a schematic diagram of a structure of a feature processing module according to some other embodiments of the present disclosure;

FIG. 4 is a schematic diagram of a structure of a feature processing module according to yet other embodiments of the present disclosure;

FIG. 5 is a schematic diagram of a structure of a feature processing module according to still yet other embodiments of the present disclosure;

FIG. 6 is a schematic diagram of a structure of a feature processing module according to yet other embodiments of the present disclosure;

FIG. 7 is a flowchart of steps of an image super-resolution method according to some other embodiments of the present disclosure;

FIG. 8 is a schematic diagram of a structure of an image super-resolution network model according to some embodiments of the present disclosure;

FIG. 9 is a schematic diagram of a structure of an image super-resolution network model according to some other embodiments of the present disclosure;

FIG. 10 is a schematic diagram of a structure of an image super-resolution apparatus according to some embodiments of the present disclosure;

FIG. 11 is a schematic diagram of a hardware structure of an electronic device according to some embodiments of the present disclosure;

FIG. 12 is a schematic diagram of a structure of a super-resolution network parameter adjustment system according to some embodiments of the present disclosure;

FIG. 13 is a schematic flowchart of a super-resolution network parameter adjustment method according to some embodiments of the present disclosure;

FIG. 14 is a schematic diagram of a structure of a feature extractor according to some embodiments of the present disclosure;

FIG. 15 is a block diagram of a structure of a super-resolution network parameter adjustment apparatus according to some embodiments of the present disclosure; and

FIG. 16 is a block diagram of a structure of an electronic device according to some embodiments of the present disclosure.

### DETAILED DESCRIPTION

For a clearer understanding of the above objectives, features, and advantages of the present disclosure, the solutions of the present disclosure will be further described below. It should be noted that the embodiments of the present disclosure and features in the embodiments may be combined with each other without conflict.

Many specific details are set forth in the following description to facilitate a full understanding of the present disclosure. However, the present disclosure may also be implemented in other ways different from those described herein. Apparently, the embodiments in the description are only some rather than all of the embodiments of the present disclosure.

It should be noted that, to clearly describe the technical solutions in the embodiments of the present disclosure, terms such as “first” and “second” are used in the embodiments of the present disclosure to distinguish between same or similar items having substantially a same function and effect. Those skilled in the art may understand that the terms such as “first” and “second” do not limit a quantity and an execution order. For example, a first image feature and a second image feature are merely for distinguishing between different features, rather than limiting an order of the features, etc.

In the embodiments of the present disclosure, terms such as “exemplary” or “for example” are used for representing an example, an illustration, or a description. Any embodiment or design solution described by “exemplary” or “for example” in the embodiments of the present disclosure should not be construed as being more preferred or more advantageous than other embodiments or design solutions. To be precise, the term “exemplary” or “for example” is intended to present a related concept in a specific manner. Furthermore, in the description of the embodiments of the present disclosure, “a plurality” means two or more, unless otherwise specified.

The inventors have found the following problems: Although an image super-resolution model has achieved good performance and visual effects, the image super-resolution model runs generally slowly, which greatly affects the efficiency of image super-resolution in practical use. The image super-resolution model runs slowly mainly for the following reason: In an image super-resolution process performed through the image super-resolution model, after feature extraction is performed on a low-resolution image, it is necessary to further process an extracted image feature to obtain a feature for obtaining, through reconstruction, a super-resolution image corresponding to the low-resolution image. However, a model structure of the image super-resolution model in the related art are very unfavorable for model acceleration. Therefore, how to improve a running speed of the image super-resolution model is an urgent problem to be solved.

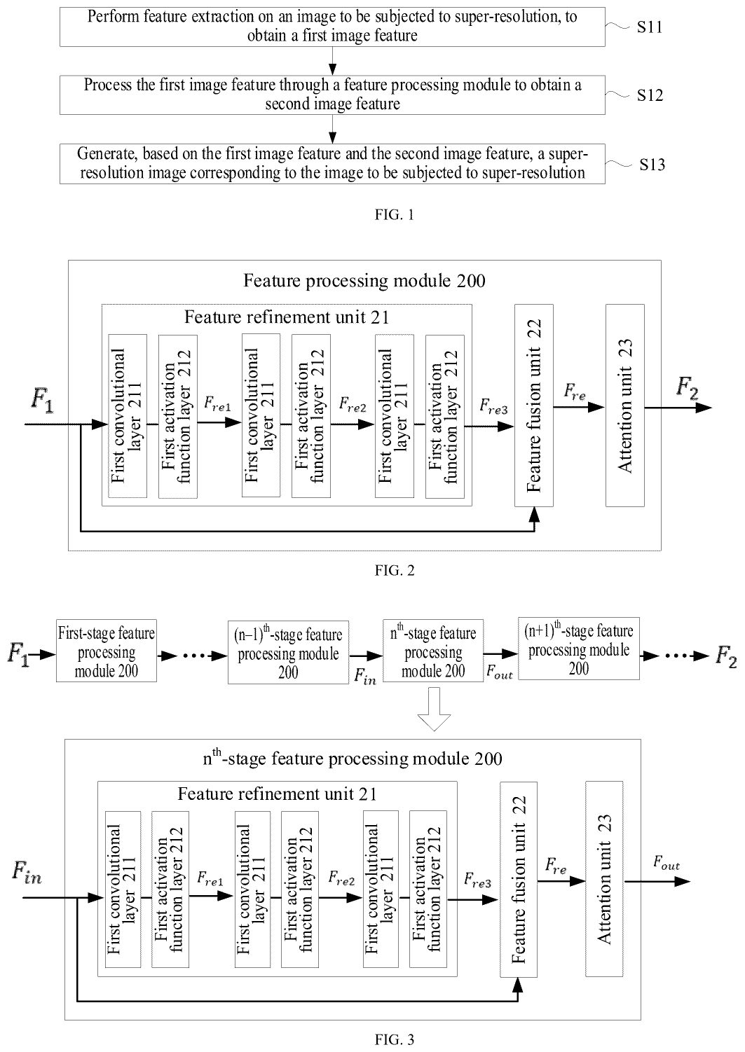

An embodiment of the present disclosure provides an image super-resolution method. Referring to FIG. 1, the image super-resolution method includes the following steps S11 to S13. A super-resolution image can be generated through a super-resolution network (an image super-resolution model).

In step S11, feature extraction is performed on an image to be subjected to super-resolution, to obtain a first image feature.

The image to be subjected to super-resolution in this embodiment of the present disclosure refers to a low-resolution image corresponding to a high-resolution image that is finally desired. The image to be subjected to super-resolution may be an image of any resolution and any format. For example, the image to be subjected to super-resolution may be an RGB image of a resolution of 960*540.

A feature extraction method for performing feature extraction on the image to be subjected to super-resolution is not limited in this embodiment of the present disclosure, as long as feature extraction can be performed on the image to be subjected to super-resolution.

In some embodiments, step S11 (performing feature extraction on the image to be subjected to super-resolution, to obtain the first image feature) includes:
processing, through a third convolutional layer, the image to be subjected to super-resolution, to obtain the first image feature.
Exemplarily, the third convolutional layer may have a convolution kernel size of 3*3, and the third convolutional layer may have a stride of 2.

In step S12, the first image feature is processed through a feature processing module to obtain a second image feature.

For example, the feature processing module includes: a feature refinement unit that includes at least one set of first convolutional layer and first activation function layer that are connected in series and is configured to process an input feature of the feature processing module; a feature fusion unit configured to perform additive fusion on the input feature of the feature processing module and an output feature of the feature refinement unit; and an attention unit (Expanded Self Attention, ESA) configured to process an output feature of the feature fusion unit to obtain an output feature of the feature processing module.

In some embodiments, step S12 (processing the first image feature through the feature processing module to obtain the second image feature) includes:
processing the first image feature through one stage of feature processing module to obtain the second image feature.

Exemplarily, referring to FIG. 2, when the first image feature is processed through only one stage of feature processing module, a model structure for implementing step S12 includes a feature processing module 200. An input feature of the feature processing module 200 is a first image feature F₁ obtained by performing feature extraction on the image to be subjected to super-resolution. An output feature of the feature processing module 200 is a second image feature F₂. The feature processing module 200 includes: a feature refinement unit 21 including at least one set of first convolutional layer 211 and first activation function layer 212 that are connected in series (FIG. 2 shows an example in which the feature refinement unit 21 includes three sets of first convolutional layers 211 and first activation function layers 212 that are connected in series), where the feature refinement unit 21 is configured to process the input feature (the first image feature F₁) of the feature processing module; a feature fusion unit 22 configured to perform additive fusion on the input feature (the first image feature F₁) of the feature processing module and an output feature of the feature refinement unit; and an attention unit 23 configured to process an output feature of the feature fusion unit to obtain the output feature (the second image feature F₂) of the feature processing module.

As shown in FIG. 2, when the first image feature is processed through only one stage of feature processing module, and the feature refinement unit 21 includes three sets of first convolutional layers 211 and first activation function layers 212 that are connected in series, a feature processing process of the feature processing module 200 includes: first, processing the first image feature F₁ through a first set of first convolutional layer 211 and first activation function layer 212 that are connected in series, and outputting a feature Fᵣₑ₁; then processing Fᵣₑ₁ through a second set of first convolutional layer 211 and first activation function layer 212 that are connected in series, and outputting a feature Fᵣₑ₂; next, processing Fᵣₑ₂ through a third set of first convolutional layer 211 and first activation function layer 212 that are connected in series, and outputting a feature Fᵣₑ₃ (the output feature of the feature refinement unit 21); later on, performing additive fusion on the first image feature F₁ and the output feature Fᵣₑ₃ of the feature refinement unit 21 through the feature fusion unit 22 to obtain the output feature Fᵣₑ of the feature fusion unit 22; and finally, processing the output feature Fᵣₑ of the feature fusion unit 22 through the attention unit 23 to obtain the second image feature F₂.

Further, feature processing of the first set of first convolutional layer 211 and first activation function layer 212 that are connected in series is represented as RM₁, feature processing of the second set of first convolutional layer 211 and first activation function layer 212 that are connected in series is represented as RM₂, feature processing of the third set of first convolutional layer 211 and first activation function layer 212 that are connected in series is represented as RM₃, and feature processing of the attention unit 23 is represented as ESA. In this case, there are the following formulas:

$${F}_{r e 1} = R {M}_{1} ( {F}_{i n} ) \qquad ( 1 )$$

$${F}_{r e 2} = R {M}_{2} ( {F}_{r e 1} ) \qquad ( 2 )$$

$${F}_{r e 3} = R {M}_{3} ( {F}_{r e 2} ) \qquad ( 3 )$$

$${F}_{r e} = {F}_{1} + {F}_{r e 3} \qquad ( 4 )$$

$${F}_{2} = E S A ( {F}_{r e} ) \qquad ( 5 )$$

In some embodiments, step S12 (processing the first image feature through the feature processing module to obtain the second image feature) includes:
processing the first image feature through a plurality of stages of feature processing modules that are connected in series, to obtain the second image feature.

Exemplarily, the plurality of stages of feature processing modules that are connected in series may include six stages of feature processing modules that are connected in series and eight stages of feature processing modules that are connected in series. This is not limited in this embodiment of the present disclosure.

Exemplarily, referring to FIG. 3, when the first image feature is processed through the plurality of stages of feature processing modules that are connected in series, a model structure for implementing step S12 includes a plurality of stages of feature processing modules 200 that are connected in series. An input feature of a first-stage feature processing module 200 is a first image feature F₁. An input feature Fᵢₙ of an n^{th}-stage feature processing module 200 is an output feature of an (n−1)^{th}-stage feature processing module 200. An output feature Fₒᵤₜ of the n^{th}-stage feature processing module 200 is an input feature of an (n+1)^{th}-stage feature processing module 200. Each feature processing module 200 processes the input feature in a manner the same as that described above. Details are not described herein again.

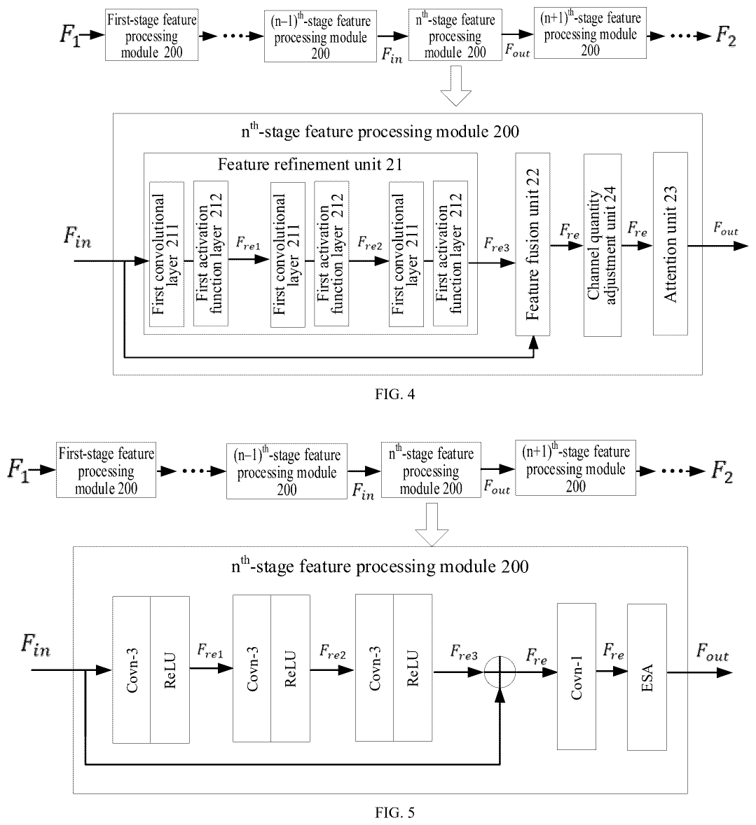

In some embodiments, based on the embodiment shown in FIG. 2 or FIG. 3, referring to FIG. 4, the feature processing module 200 further includes a channel quantity adjustment unit 24.

The channel quantity adjustment unit 24 is configured to adjust the output feature Fᵣₑ of the feature fusing unit 22 into a feature having a same quantity of channels as the first image feature F₁ before the attention unit 23 processes the output feature Fᵣₑ of the feature fusing unit 22.

That is, before the attention unit 23 performs feature processing, the channel quantity adjustment unit 24 adjusts the output feature Fᵣₑ of the feature fusion unit 22 into the feature having the same quantity of channels as the first image feature F₁, and then inputs the feature into the attention unit 23.

Exemplarily, both a quantity of channels of an output feature of the channel quantity adjustment unit 24 and a quantity of channels of the first feature F₁ may be 52.

In some embodiments, the channel quantity adjustment unit 24 includes a second convolutional layer, where the second convolutional layer has a convolution kernel size of 1*1.

In the above embodiment, since the output feature Fᵣₑ of the feature fusion unit 22 is adjusted into the feature having the same quantity of channels as the first image feature F₁ through the second convolutional layer having the convolution kernel size of 1*1, the output feature of the feature fusion unit can be adjusted into the feature having the same quantity of channels as the first image feature in the above embodiment, without changing a spatial size of the output feature Fᵣₑ of the feature fusion unit 22.

In some embodiments, the first convolutional layer 211 has a convolution kernel size of 3*3.

In some embodiments, an activation function at the first activation function layer 212 is a linear rectification function (ReLU).

Further, when the first convolutional layer 211 has the convolution kernel size of 3*3, the activation function at the first activation function layer 212 is ReLU, and the channel quantity adjustment unit 23 includes the second convolutional layer having the convolution kernel size of 1*1, a network model structure for implementing step S12 may be shown in FIG. 5.

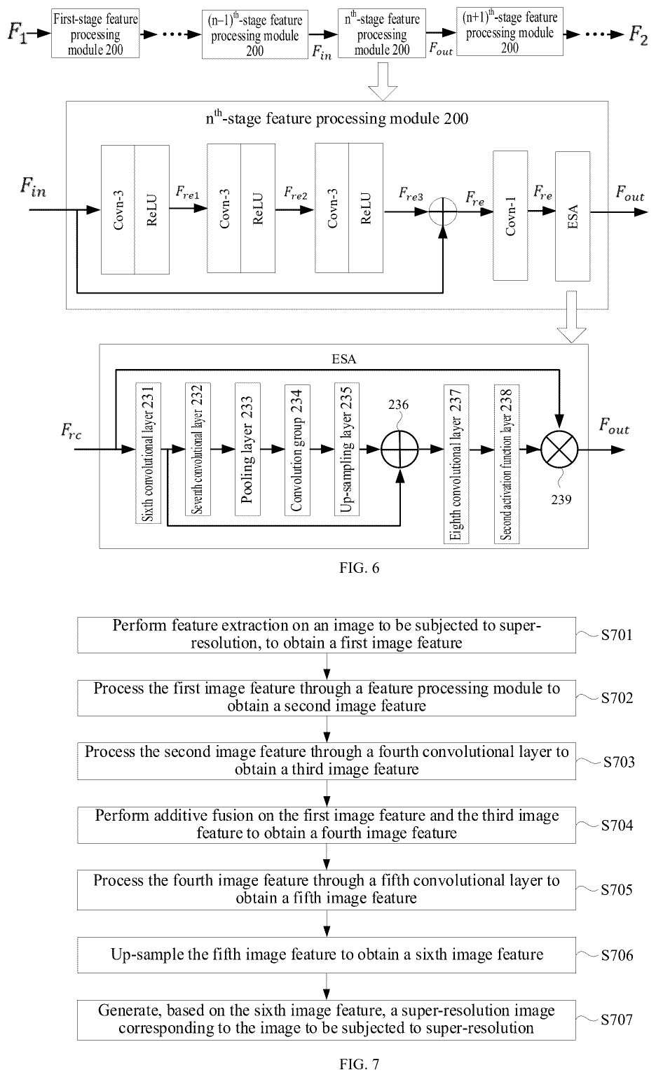

In some embodiments, referring to FIG. 6, the attention unit 23 includes:
a sixth convolutional layer 231, a seventh convolutional layer 232, a pooling layer 233, a convolution group 234, an up-sampling layer 235, a first fusion layer 236, an eighth convolutional layer 237, a second activation function layer 238, and a second fusion layer 239.

The sixth convolutional layer 231 has a convolution kernel size of 1*1, and is configured to process the output feature of the channel quantity adjustment unit.

The seventh convolutional layer 232 has a convolution kernel size 3*3 and a stride of a preset value, and is configured to process an output feature of the sixth convolutional layer.

The pooling layer 233 is configured to process an output feature of the seventh convolutional layer.

The convolution group 234 includes a plurality of convolutional layers that are connected in series and each of which has a convolution kernel size of 3*3, and is configured to process an output feature of the pooling layer.

The up-sampling layer 235 is configured to up-sample the output feature of the pooling layer.

The first fusion layer 236 is configured to perform additive fusion on the output feature of the sixth convolutional layer and an output feature of the up-sampling layer.

The eighth convolutional layer 237 has a convolution kernel size of 1*1, and is configured to process an output feature of the first fusion layer.

The second activation function layer 238 is configured to process the output feature of the first fusion layer.

The second fusion layer 239 is configured to perform multiplicative fusion on an output feature of the second activation function layer and the output feature of the channel quantity adjustment unit to obtain the output feature of the feature processing module.

In step S13, a super-resolution image corresponding to the image to be subjected to super-resolution is generated based on the first image feature and the second image feature.

In the image super-resolution method provided in this embodiment of the present disclosure, feature extraction is first performed on the image to be subjected to super-resolution, to obtain the first image feature. Then, the first image feature is processed through the feature processing module to obtain the second image feature. Finally, the super-resolution image corresponding to the image to be subjected to super-resolution is generated based on the first image feature and the second image feature. The feature processing module includes: the feature refinement unit that includes the at least one set of first convolutional layer and first activation function layer that are connected in series and is configured to process the input feature of the feature processing module; the feature fusion unit configured to perform additive fusion on the input feature of the feature processing module and the output feature of the feature refinement unit; and the attention unit configured to process the output feature of the feature fusion unit to obtain the output feature of the feature processing module. Compared with the related art in which image features are required to be processed in parallel in the image super-resolution model (i.e., the super-resolution network), this embodiment of the present disclosure can improve a running speed of the image super-resolution model because in the image super-resolution method provided in this embodiment of the present disclosure, the units in the feature processing module perform feature processing in a serial manner when the first image feature is processed through the feature processing module.

In some embodiments, the feature processing module in the above embodiment may be replaced with a model structure that distills and refines features in parallel at each stage and processes the features progressively at multiple stages. An image super-resolution model after replacement can achieve an image super-resolution effect similar to that of the image super-resolution model before replacement. However, as the image super-resolution model after replacement needs to distill and refine the features in parallel at each stage when performing feature processing, a running speed of the image super-resolution model after replacement may be much lower than that of the image super-resolution model before replacement.

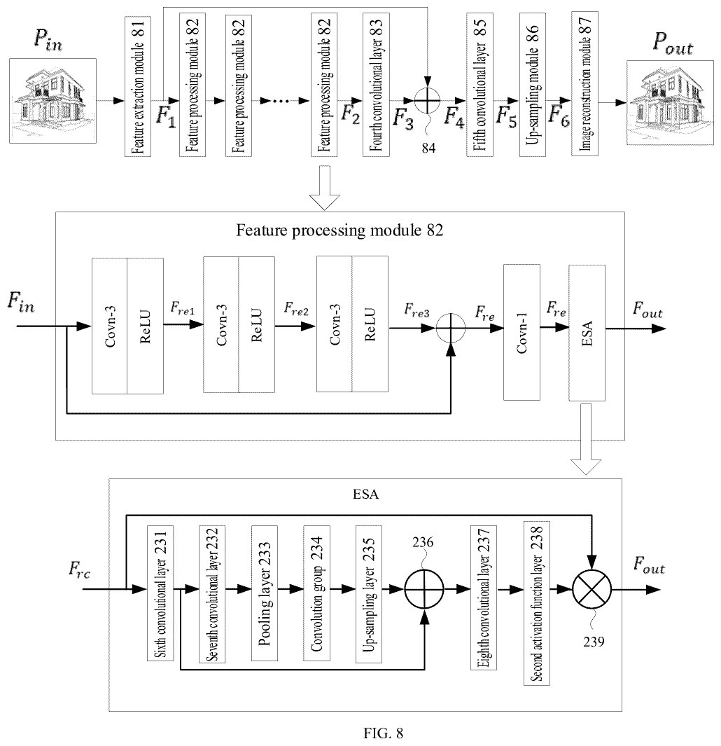

As an extension and refinement to the above embodiment, an embodiment of the present disclosure provides another image super-resolution method. Referring to FIG. 7, the image super-resolution method includes the following steps S701 to S707.

In step S701, feature extraction is performed on an image to be subjected to super-resolution, to obtain a first image feature.

In some embodiments, step S701 (performing feature extraction on the image to be subjected to super-resolution, to obtain the first image feature) includes:
processing, through a third convolutional layer, the image to be subjected to super-resolution, to obtain the first image feature.

In some embodiments, the third convolutional layer has a convolution kernel size of 3*3.

That is, the image to be subjected to super-resolution is processed through a convolutional layer having a convolution kernel size of 3*3, to obtain an image feature of the image to be subjected to super-resolution, and the image feature of the image to be subjected to super-resolution is used as the first image feature in this embodiment of the present disclosure.

In step S702, the first image feature is processed through a feature processing module to obtain a second image feature.

In some embodiments, the feature processing module includes: a feature refinement unit that includes at least one set of first convolutional layer and first activation function layer that are connected in series and is configured to process an input feature of the feature processing module; a feature fusion unit configured to perform additive fusion on the input feature of the feature processing module and an output feature of the feature refinement unit; and an attention unit configured to process an output feature of the feature fusion unit to obtain an output feature of the feature processing module.

In step S703, the second image feature is processed through a fourth convolutional layer to obtain a third image feature.

In some embodiments, the fourth convolutional layer has a convolution kernel size of 3*3.

In step S704, additive fusion is performed on the first image feature and the third image feature to obtain a fourth image feature.

In step S705, the fourth image feature is processed through a fifth convolutional layer to obtain a fifth image feature.

In some embodiments, the fifth convolutional layer has a convolution kernel size of 3*3.

In step S706, the fifth image feature is up-sampled to obtain a sixth image feature.

In step S707, a super-resolution image corresponding to the image to be subjected to super-resolution is generated based on the sixth image feature.

Exemplarily, referring to FIG. 8 in conjunction with FIG. 2 to FIG. 6, an image super-resolution network model (i.e., a super-resolution network) shown in FIG. 8 for implementing the image super-resolution method includes a feature extraction module 81, a plurality of stages of feature processing modules 82 that are connected in series, a fourth convolutional layer 83, a feature fusion module 84, a fifth convolutional layer 85, an up-sampling module 86, and an image reconstruction module 87.

A process for implementing image super-resolution by the image super-resolution network model shown in FIG. 8 includes:
first, performing, through the feature extraction module 81, feature extraction on an image to be subjected to super-resolution Pᵢₙ, to obtain a first image feature F₁; then, processing the first image feature F₁ through the plurality of stages of feature processing modules 82 that are connected in series, to obtain a second image feature F₂; next, processing the second image feature F₂ through the fourth convolutional layer 83 to obtain a third image feature F₃; later on, fusing the first image feature F₁ and the third image feature F₃ through the feature fusion module 84 to obtain a fourth image feature F₄, and processing the fourth image feature F₄ through the fifth convolutional layer 85 to obtain a fifth image feature F₅; and finally, up-sampling the fifth image feature F₅ through the up-sampling module 86 to obtain a sixth image feature F₆, and performing image reconstruction based on the sixth image feature F₆ through the image reconstruction module 87, to obtain a super-resolution image Pₒᵤₜ corresponding to the image to be subjected to super-resolution Pᵢₙ.

Further, when the third convolutional layer, the fourth convolutional layer, and the fifth convolutional layer are all convolutional layers having a convolution kernel size of 3*3, the image super-resolution network model shown in FIG. 8 for implementing the image super-resolution method can be shown in FIG. 9.

Based on the same inventive concept, as an implementation of the above method, an embodiment of the present disclosure further provides an image super-resolution apparatus. The apparatus embodiment corresponds to the above method embodiment. For ease of reading, the details in the above method embodiment are not described again in the apparatus embodiment. However, it should be clear that the image super-resolution apparatus in this embodiment can implement all the content in the above method embodiment correspondingly.

With regard to training of a super-resolution network, in the related art, before an image super-resolution technique is implemented through the super-resolution network, the constructed super-resolution network is usually first trained with image sample data (a low-resolution image and a high-resolution image) and a contrastive loss function, to obtain a super-resolution network with good effects (a feature of a reconstructed image is as close as possible to a feature of the high-resolution image and as far away as possible from a feature of the low-resolution image). Specifically, reconstruction from the low-resolution image is first performed through the super-resolution network to obtain the reconstructed image. Then, feature information of the high-resolution image, feature information of the reconstructed image, and feature information of the low-resolution image are separately extracted through a feature extractor. Finally, a parameter of the super-resolution network is adjusted based on the feature information of the high-resolution image, the feature information of the reconstructed image, the feature information of the low-resolution image, and a contrastive loss function value obtained through calculation for the contrastive loss function, to implement training of the super-resolution network.

The inventors have found that a deep feature extractor is usually used in a current training process of the super-resolution network. However, a deep feature extracted by the deep feature extractor has no fine and accurate image edges and high-frequency features, resulting in a failure in adjusting the parameter of the super-resolution network correctly. As such, the reconstructed image obtained through reconstruction by using the super-resolution network usually has a lot of artifacts, which may not only lead to a distortion of the reconstructed image, but also have great impact on both subjective quality and an objective indicator peak signal-to-noise ratio (PSNR) of the reconstructed image.

In view of this, the present disclosure further provides a super-resolution network parameter adjustment apparatus and, etc., which are described below.

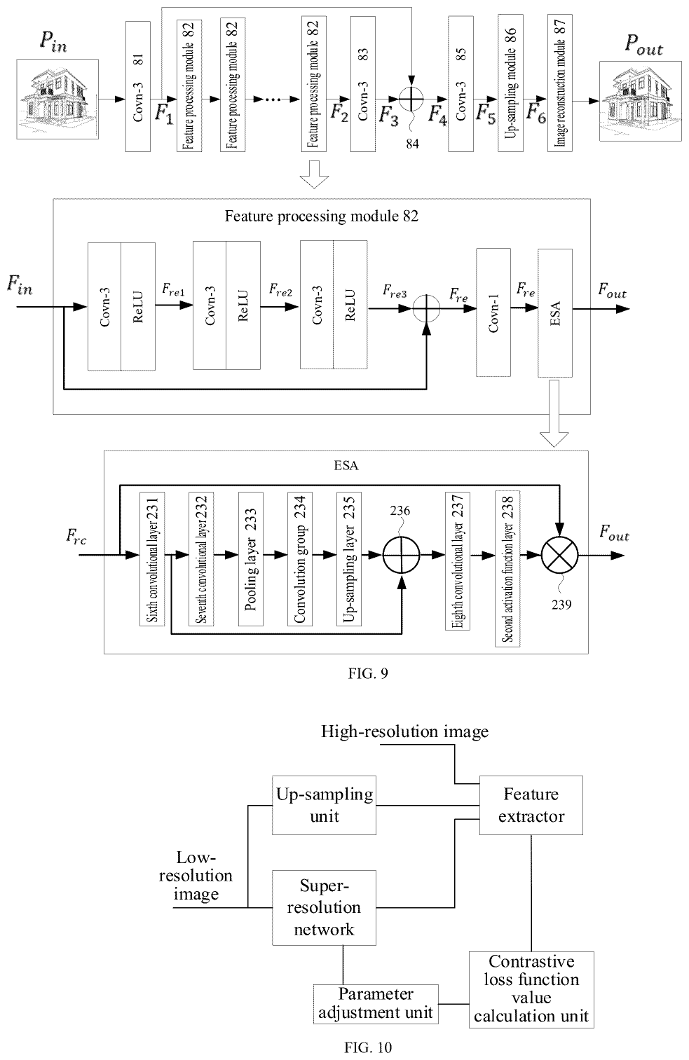

First, FIG. 10 shows a possible super-resolution network parameter adjustment system according to an embodiment of the present disclosure. As shown in FIG. 10, the super-resolution network parameter adjustment system includes a super-resolution network, an up-sampling unit, a feature extractor, a contrastive loss function value calculation unit, and a parameter adjustment unit. The system may further include other units, such as another loss function unit. This can be specifically determined based on an actual situation, and is not limited herein. The super-resolution network is configured to perform reconstruction from the low-resolution image to obtain the reconstructed image of a preset resolution. The up-sampling unit is configured to up-sample the low-resolution image to obtain an up-sampled image of the preset resolution. The feature extractor is configured to separately extract the feature information of the reconstructed image, the feature information of the high-resolution image (a resolution of the high-resolution image is the preset resolution), and feature information of the up-sampled image. The contrastive loss function value calculation unit is configured to calculate the contrastive loss function value based on the feature information of the reconstructed image, the feature information of the high-resolution image, the feature information of the up-sampled image, and the contrastive loss function. The parameter adjustment unit is configured to determine a parameter adjustment solution for the super-resolution network based on the contrastive loss function value, and adjust the parameter of the super-resolution network to obtain the super-resolution network with better effects.

An electronic device in the embodiments of the present disclosure may be a mobile phone, a tablet computer, a notebook computer, a palmtop computer, a vehicle-mounted electronic device, an ultra-mobile personal computer (UMPC), a netbook, a personal digital assistant (PDA), a personal computer (PC), etc. This is not specifically limited in the embodiments of the present disclosure.

A super-resolution network parameter adjustment method provided in the embodiments of the present disclosure may be performed by the above electronic device, or may be performed by a functional module and/or a functional entity that is in the electronic device and that can implement the super-resolution network parameter adjustment method. This can be specifically determined based on an actual usage requirement, and is not limited in the embodiments of the present disclosure.

The super-resolution network parameter adjustment method provided in the embodiments of the present disclosure will be described in detail below through specific embodiments and application scenarios thereof in conjunction with the accompanying drawings.

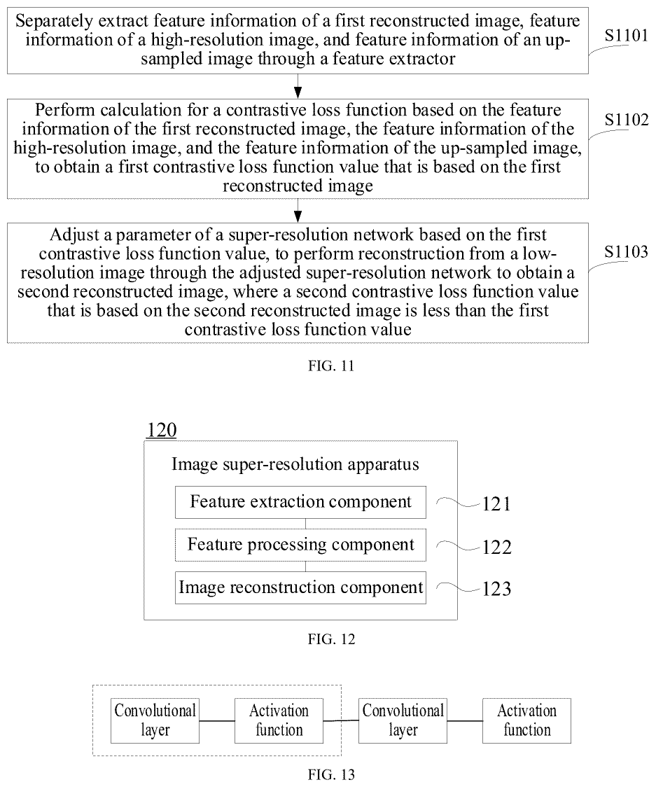

As shown in FIG. 11, an embodiment of the present disclosure provides a parameter adjustment parameter adjustment method. The method may include the following steps S1101 to S1103.

In step S1101, feature information of a first reconstructed image, feature information of a high-resolution image, and feature information of an up-sampled image are separately extracted through a feature extractor.

In some embodiments, the feature extractor includes at least one convolution activation module, and the convolution activation module includes a convolutional layer and an activation function.

In some embodiments, the feature extractor may further include other operators that may not change a resolution. This can be specifically determined based on an actual situation, and is not limited herein.

In some embodiments, the feature extractor includes at least one convolution activation module, and each convolution activation module includes a convolutional layer and an activation function.

In some embodiments, the feature extractor includes at least one convolution activation module connected in series.

In some embodiments, each convolution activation module includes at least one convolutional layer and at least one activation function, different convolution activation modules may include the same or different quantities of convolutional layers, and different convolution activation modules may include the same or different quantities of activation functions. This can be specifically determined based on an actual situation, and is not limited herein.

Exemplarily, as shown in FIG. 13, the feature extractor includes two convolution activation modules connected in series. One convolution activation module includes one convolutional layer and one activation function. The portion indicated by the dashed box in the figure is a convolution activation module.

In this embodiment of the present disclosure, the feature extractor includes the at least one convolution activation module, and there is no operator that may change the resolution in the feature extractor, such as conv_s2, max_pooling, and avg_pooling. Therefore, the feature extractor maintains a high resolution without down-sampling when performing feature extraction on the first reconstructed image, the high-resolution image, and the up-sampled image, and there is no feature loss in the obtained feature information of the first reconstructed image, the feature information of the high-resolution image, and the feature information of the up-sampled image. As such, a fine and accurate image edge and high-frequency feature can be extracted, a parameter of a super-resolution network can be adjusted correctly by using a contrastive loss function value obtained based on the feature information of the first reconstructed image, the feature information of the high-resolution image, and the feature information of the up-sampled image, which are extracted by the feature extractor, and a second reconstructed image obtained through reconstruction by using the adjusted super-resolution network does not have a lot of artifacts. This avoids a distortion of the second reconstructed image caused by artifacts, and improves subjective quality and an objective indicator peak signal-to-noise ratio of the second reconstructed image.

In some embodiments, the at least one convolution activation module may have a same convolutional layer, or each convolution activation module may have a different convolutional layer. This can be specifically determined based on an actual situation, and is not limited herein.

In this embodiment of the present disclosure, the convolutional layer of each convolution activation module is the same. This can simplify a structure of the feature extractor, facilitate feature extraction, and ensure extraction of a fine and accurate image edge and high-frequency feature.

In some embodiments, the convolutional layer of each convolution activation module is the same, and the convolutional layer of each convolution activation module has a convolution kernel size of 3×3 and a quantity of channels of 64.

It can be understood that the convolution kernel size of each convolutional layer may be another value, and the quantity of channels may be another value as well. This can be specifically determined based on an actual situation, and is not limited herein.

In this embodiment of the present disclosure, the convolutional layer of each convolution activation module has the convolution kernel size of 3×3 and the quantity of channels of 64. This can simplify the structure of the feature extractor, facilitate feature extraction, and ensure extraction of the fine and accurate image edge and high-frequency feature.

In some embodiments, the first reconstructed image is a super-resolution image obtained through reconstruction from a low-resolution image by using the super-resolution network. The high-resolution image and the low-resolution image are training sample images for the super-resolution network. The high-resolution image and the low-resolution image are images of same visual content at different resolutions. The up-sampled image is an image obtained by performing up-sampling on the low-resolution image. The first reconstructed image, the high-resolution image, and the up-sampled image have a same resolution.

It can be understood that the first reconstructed image is an image of a preset resolution obtained through reconstruction from the low-resolution image by using the super-resolution network, the high-resolution image is a sample image of the preset resolution corresponding to the low-resolution image, and the up-sampled image is an image of the preset resolution obtained by performing the up-sampling on the low-resolution image.

It can be understood that resolutions of the first reconstructed image, the high-resolution image, and the up-sampled image are all the preset resolution, and a resolution of the low-resolution image is lower than the preset resolution.

The low-resolution image and the high-resolution image are of different resolutions, but present the same visual content (an image picture or image content).

In some embodiments, the feature extractor provided in this embodiment of the present disclosure may be trained, or the feature extractor provided in this embodiment of the present disclosure may not be trained. If the feature extractor is not trained, all weights in the feature extractor may be initialized randomly.

In this embodiment of the present disclosure, the feature extractor does not require training, and all the weights may be initialized randomly. On the one hand, the feature extractor can extract the fine and accurate image edge and high-frequency feature, and a contrastive loss function that is based on the high-frequency feature extractor can provide more precise supervisory information in a training process, to correctly and effectively guide the training process of the super-resolution network, greatly reduce the artifacts of the reconstructed image, and improve the quality of the reconstructed image. On the other hand, the feature extractor does not require training, so that a training process of the feature extractor can be omitted, and the training efficiency of the super-resolution network can be improved.

In some embodiments, the up-sampling is bicubic interpolation.

In some embodiments, the up-sampling may alternatively be nearest neighbor interpolation, bilinear interpolation, transposed convolution, etc. This can be specifically determined based on an actual situation, and is not limited herein.

In this embodiment of the present disclosure, the up-sampled image obtained based on the bicubic interpolation processing has a higher image resolution achieved through content of the low-resolution image, without introducing more information, so that the feature information obtained by performing feature extraction on the up-sampled image through the feature extractor is closer to the feature information of the low-resolution image. Therefore, an accurate contrastive loss function value can be calculated, and then the parameter of the super-resolution network can be correctly adjusted based on the contrastive loss function value, to make a feature of the second reconstructed image obtained through reconstruction from the low-resolution image by using the adjusted super-resolution network closer to a feature of the high-resolution image and further away from a feature of the low-resolution image.

In step S1102, calculation is performed for the contrastive loss function based on the feature information of the first reconstructed image, the feature information of the high-resolution image, and the feature information of the up-sampled image, to obtain a first contrastive loss function value that is based on the first reconstructed image.

In some embodiments, the contrastive loss function is a ratio of a first difference term to a second difference term, where the first difference term is used for representing a difference between the first reconstructed image and the high-resolution image, and the second difference term is used for representing a difference between the up-sampled image and the high-resolution image.

It can be understood that if the contrastive loss function value calculated based on the contrastive loss function is smaller, effects of the reconstructed image obtained based on the super-resolution network are better, i.e., the feature of the reconstructed image is closer to the feature of the high-resolution image and further away from the feature of the low-resolution image.

In this embodiment of the present disclosure, the contrastive loss function is the ratio of the first difference term to the second difference term, so that the training process of the super-resolution network is more stable, and effects of the reconstructed image are better.

In some embodiments, the first difference term is an L1 distance between the feature information of the first reconstructed image and the feature information of the high-resolution image; and the second difference term is an L1 distance between the feature information of the up-sampled image and the feature information of the high-resolution image.

The L1 distance is a Manhattan distance, i.e., a sum of absolute values of differences between pixel values of corresponding pixels in feature information of two images, for which a formula is:

$${d}_{L 1} = {\sum }_{P = 1}^{K} \vert {I}_{1}^{P} - {I}_{2}^{P} \vert \qquad ( 5 )$$

d_{L1} is an L1 distance between feature information of an image 1 and feature information of an image 2. I₁^{P} is a pixel value of a P^{th} pixel in the feature information of the image 1. I₂^{P} is a pixel value of a P^{th} pixel in the feature information of the image 2. K is a quantity of pixels in the feature information of the image 1 and the feature information of the image 2.

Accordingly, a formula for the contrastive loss function is:

$$contrastive\_loss = \frac{L 1 ( ϕ ( anchor ) , ϕ ( positive ) )}{L 1 ( ϕ ( positive ) , ϕ ( negative ) )} \qquad ( 6 )$$

anchor represents the first reconstructed image. ϕ(anchor) represents the feature information of the first reconstructed image. positive represents the high-resolution image. ϕ(positive) represents the feature information of the high-resolution image. negative represents the up-sampled image. ϕ(negative) represents the feature information of the up-sampled image. L1(ϕ(anchor), ϕ(positive)) represents the first difference term. L1(ϕ(positive), ϕ(negative)) represents the second difference term.

In this embodiment of the present disclosure, the first difference term is the L1 distance between the feature information of the first reconstructed image and the feature information of the high-resolution image, and the second difference term is the L1 distance between the feature information of the up-sampled image and the feature information of the high-resolution image. Therefore, the training process of the super-resolution network is more stable, and the effects of the reconstructed image are better.

In this embodiment of the present disclosure, the high-frequency feature extractor the above contrastive loss function are designed. The feature extractor can extract the fine and accurate high-frequency feature, and the above contrastive loss function that is based on the high-frequency feature can provide more precise supervisory information in the training process, to correctly and effectively guide the training process of the super-resolution network, greatly reduce the artifacts of the reconstructed image, and improve the quality of the reconstructed image.

In some embodiments, the first difference term may be an L2 distance between the feature information of the first reconstructed image and the feature information of the high-resolution image; and the second difference term may be an L2 distance between the feature information of the up-sampled image and the feature information of the high-resolution image.

The L2 distance is a Euclidean distance, i.e., a square root of a sum of squares of differences between pixel values of corresponding pixels in feature information of two images, for which a formula is:

$${d}_{L 2} = \sqrt{{\sum }_{P = 1}^{K} {( {I}_{1}^{P} - {I}_{2}^{P} )}^{2}} \qquad ( 7 )$$

d_{L2} is an L2 distance between feature information of an image 1 and feature information of an image 2. I₁^{P} is a pixel value of a P^{th} pixel in the feature information of the image 1. I₂^{P} is a pixel value of a P^{th} pixel in the feature information of the image 2. K is a quantity of pixels in the feature information of the image 1 and the feature information of the image 2.

Accordingly, a formula for the contrastive loss function is:

$$contrastive\_loss = \frac{L 2 ( ϕ ( anchor ) , ϕ ( positive ) )}{L 2 ( ϕ ( positive ) , ϕ ( negative ) )} \qquad ( 8 )$$

anchor represents the first reconstructed image. ϕ(anchor) represents the feature information of the first reconstructed image. positive represents the high-resolution image. ϕ(positive) represents the feature information of the high-resolution image. negative represents the up-sampled image. ϕ(negative) represents the feature information of the up-sampled image. L2(ϕ(anchor), ϕ(positive)) represents the first difference term. L2(ϕ(positive), ϕ(negative)) represents the second difference term.

In this embodiment of the present disclosure, the first difference term is the L2 distance between the feature information of the first reconstructed image and the feature information of the high-resolution image, and the second difference term is the L2 distance between the feature information of the up-sampled image and the feature information of the high-resolution image. Therefore, the training process of the super-resolution network is more stable, and the effects of the reconstructed image are better.

In some embodiments, another formula for representing the difference between the first reconstructed image and the high-resolution image may be used for the first difference term, which can be specifically determined based on an actual situation and is not limited herein. Another formula for representing the difference between the high-resolution image and the low-resolution image may be used for the second difference term, which can be specifically determined based on an actual situation.

In some embodiments, the contrastive loss function is a ratio of a third difference term to a fourth difference term, where the third difference term is used for representing a difference between the first reconstructed image and the high-resolution image, and the fourth difference term is used for representing a difference between the first reconstructed image and the up-sampled image.

It can be understood that if the contrastive loss function value calculated based on the contrastive loss function is smaller, effects of the reconstructed image obtained based on the super-resolution network are better, i.e., the feature of the reconstructed image is closer to the feature of the high-resolution image and further away from the feature of the low-resolution image.

In this embodiment of the present disclosure, the contrastive loss function is the ratio of the third difference term to the fourth difference term, so that the training process of the super-resolution network is more stable, and effects of the reconstructed image are better.

In some embodiments, the third difference term is an L1 distance between the feature information of the first reconstructed image and the feature information of the high-resolution image; and the fourth difference term is an L1 distance between the feature information of the first reconstructed image and the feature information of the up-sampled image.

For descriptions of the L1 distance. reference may be made to the above related descriptions of the L1 distance, and details are not described herein again.

Accordingly, a formula for the contrastive loss function is:

$$contrastive\_loss = \frac{L 1 ( ϕ ( anchor ) , ϕ ( positive ) )}{L 1 ( ϕ ( anchor ) , ϕ ( negative ) )} \qquad ( 9 )$$

anchor represents the first reconstructed image. ϕ(anchor) represents the feature information of the first reconstructed image. positive represents the high-resolution image. ϕ(positive) represents the feature information of the high-resolution image. negative represents the up-sampled image. ϕ(negative) represents the feature information of the up-sampled image. L1(ϕ(anchor), ϕ(positive)) represents the third difference term. L1(ϕ(anchor), ϕ(negative)) represents the fourth difference term.

In this embodiment of the present disclosure, the third difference term is the L1 distance between the feature information of the first reconstructed image and the feature information of the high-resolution image, and the fourth difference term is an L1 distance between the feature information of the first reconstructed image and the feature information of the up-sampled image. Therefore, the training process of the super-resolution network is more stable, and the effects of the reconstructed image are better.

In some embodiments, the third difference term may be an L2 distance between the feature information of the first reconstructed image and the feature information of the high-resolution image; and the fourth difference term may be an L2 distance between the feature information of the first reconstructed image and the feature information of the up-sampled image.

For descriptions of the L2 distance. reference may be made to the above related descriptions of the L2 distance, and details are not described herein again.

Accordingly, a formula for the contrastive loss function is:

$$contrastive\_loss = \frac{L 2 ( ϕ ( anchor ) , ϕ ( positive ) )}{L 2 ( ϕ ( anchor ) , ϕ ( negative ) )} \qquad ( 10 )$$

anchor represents the first reconstructed image. ϕ(anchor) represents the feature information of the first reconstructed image. positive represents the high-resolution image. ϕ(positive) represents the feature information of the high-resolution image. negative represents the up-sampled image. ϕ(negative) represents the feature information of the up-sampled image. L2(ϕ(anchor), #ϕ(positive)) represents the third difference term. L2(#(anchor), #ϕ(negative)) represents the fourth difference term.

In this embodiment of the present disclosure, the third difference term is the L2 distance between the feature information of the first reconstructed image and the feature information of the high-resolution image, and the fourth difference term is the L2 distance between the feature information of the first reconstructed image and the feature information of the up-sampled image. Therefore, the training process of the super-resolution network is more stable, and the effects of the reconstructed image are better.

In some embodiments, another formula for representing the difference between the first reconstructed image and the high-resolution image may be used for the third difference term, which can be specifically determined based on an actual situation and is not limited herein. Another formula for representing the difference between the first reconstructed image and the low-resolution image may be used for the fourth difference term, which can be specifically determined based on an actual situation.

In some embodiments, another formula may be used for the contrastive loss function, which can be specifically determined based on an actual situation and is not limited herein.

In step S1103, the parameter of the super-resolution network is adjusted based on the first contrastive loss function value, to perform reconstruction from the low-resolution image through the adjusted super-resolution network to obtain the second reconstructed image, where a second contrastive loss function value that is based on the second reconstructed image is less than the first contrastive loss function value.

For a process of obtaining the second contrastive loss function value, reference may be made to the process of obtaining the first contrastive loss function value in step S1101 and step S1102, and details are not described herein again.

It can be understood that the second contrastive loss function value that is based on the second reconstructed image is less than the first contrastive loss function value, such that a difference between the second reconstructed image and the high-resolution image is less than the difference between the first reconstructed image and the high-resolution image, and a difference between the second reconstructed image and the low-resolution image is greater than the difference between the first reconstructed image and the low-resolution image. That is, the feature of the second reconstructed image is closer to the feature of the high-resolution image and further away from the feature of the low-resolution image than that of the first reconstructed image. This shows that after the super-resolution network is adjusted based on the first contrastive loss function value, the effects of the reconstructed image obtained through the adjusted super-resolution network are better.

It can be understood that step S1101 and step S1102 are re-performed based on the second reconstructed image (the first reconstructed image is replaced with the second reconstructed image during this process) to obtain a contrastive loss function value that is based on the second reconstructed image. If the contrastive loss function value that is based on the second reconstructed image is less than or equal to a preset threshold, the training of the super-resolution network is completed; or if the contrastive loss function value that is based on the second reconstructed image is not less than or equal to a preset threshold, step S1103 is re-performed to obtain a new adjusted super-resolution network, and then step S1101 to step S1103 are repeatedly performed. When an obtained contrastive loss function value is less than or equal to the preset threshold, the training of the super-resolution network is completed; or when an obtained contrastive loss function value is not less than or equal to the preset threshold, the training continues.

Compared with the related art, the technical solution provided in this embodiment of the present disclosure has the following advantages. In this embodiment of the present disclosure, the feature information of the first reconstructed image, the feature information of the high-resolution image, and the feature information of the up-sampled image are separately extracted through the feature extractor, where the feature extractor includes the at least one convolution activation module, and the convolution activation module includes the convolutional layer and the activation function. Calculation is performed for the contrastive loss function based on the feature information of the first reconstructed image, the feature information of the high-resolution image, and the feature information of the up-sampled image, to obtain the first contrastive loss function value that is based on the first reconstructed image. The parameter of the super-resolution network is adjusted based on the first contrastive loss function value, and reconstruction is performed from the low-resolution image based on the adjusted super-resolution network, to obtain the second reconstructed image, where the second contrastive loss function value that is based on the second reconstructed image is less than the first contrastive loss function value. The feature extractor includes the at least one convolution activation module, and there is no operator that may change the resolution in the feature extractor. Therefore, the feature extractor maintains a high resolution without down-sampling when performing feature extraction on the first reconstructed image, the high-resolution image, and the up-sampled image, and there is no feature loss in the obtained feature information of the first reconstructed image, the feature information of the high-resolution image, and the feature information of the up-sampled image. As such, the fine and accurate image edge and high-frequency feature can be extracted, the parameter of the super-resolution network can be adjusted correctly by using the contrastive loss function value obtained based on the feature information of the first reconstructed image, the feature information of the high-resolution image, and the feature information of the up-sampled image, which are extracted by the feature extractor, and the second reconstructed image obtained through reconstruction by using the adjusted super-resolution network does not have a lot of artifacts. This avoids a distortion of the second reconstructed image caused by artifacts, and improves subjective quality and an objective indicator peak signal-to-noise ratio of the second reconstructed image.

An embodiment of the present disclosure provides an image super-resolution apparatus. FIG. 12 is a schematic diagram of a structure of the image super-resolution apparatus. As shown in FIG. 12, the image super-resolution apparatus 120 includes a feature extraction component 121, a feature processing component 122, and an image reconstruction component 123.

The feature extraction component 121 is configured to perform feature extraction on an image to be subjected to super-resolution, to obtain a first image feature.

The feature processing component 122 is configured to process the first image feature through a feature processing module to obtain a second image feature, where the feature processing module includes: a feature refinement unit that includes at least one set of first convolutional layer and first activation function layer that are connected in series and is configured to process an input feature of the feature processing module; a feature fusion unit configured to perform additive fusion on the input feature of the feature processing module and an output feature of the feature refinement unit; and an attention unit configured to process an output feature of the feature fusion unit to obtain an output feature of the feature processing module.

The image reconstruction component 123 is configured to generate, based on the first image feature and the second image feature, a super-resolution image corresponding to the image to be subjected to super-resolution.

In some embodiments, the feature processing module further includes a channel quantity adjustment unit.

The channel quantity adjustment unit is configured to adjust the output feature of the feature fusion unit into a feature having a same quantity of channels as the first image feature before the attention unit processes the output feature of the feature fusion unit.

In some embodiments, the feature processing component 102 is specifically configured to process the first image feature through a plurality of stages of feature processing modules that are connected in series, to obtain the second image feature.

In some embodiments, an activation function at the first activation function layer is a linear rectification function ReLU.

In some embodiments, the channel quantity adjustment unit includes a second convolutional layer.

The second convolutional layer has a convolution kernel size of 1*1.

In some embodiments, the feature extraction component 101 is specifically configured to convolve, through a third convolutional layer, the image to be subjected to super-resolution, to obtain the first image feature.

In some embodiments, the image reconstruction component 103 is specifically configured to: process the second image feature through a fourth convolutional layer to obtain a third image feature; perform additive fusion on the first image feature and the third image feature to obtain a fourth image feature; process the fourth image feature through a fifth convolutional layer to obtain a fifth image feature; up-sample the fifth image feature to obtain a sixth image feature; and generate, based on the sixth image feature, the super-resolution image corresponding to the image to be subjected to super-resolution.

The image super-resolution apparatus provided in this embodiment can perform the image super-resolution method provided in the above method embodiment, with similar implementation principles and technical effects. Details are not described herein again.

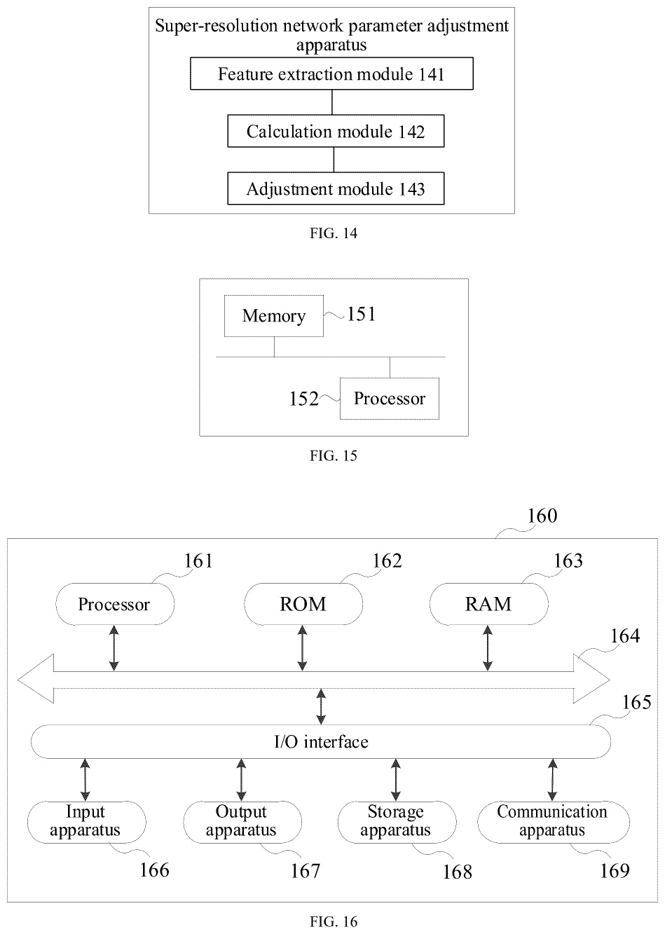

The present disclosure further provides a super-resolution network parameter adjustment apparatus. FIG. 14 is a block diagram of a structure of the super-resolution network parameter adjustment apparatus according to an embodiment of the present disclosure. As shown in FIG. 14, the super-resolution network parameter adjustment apparatus includes a feature extraction module 141, a calculation module 142, and an adjustment module 143. The feature extraction module 141 is configured to separately extract feature information of a first reconstructed image, feature information of a high-resolution image, and feature information of an up-sampled image through a feature extractor, where the feature extractor includes at least one convolution activation module, the convolution activation module includes a convolutional layer and an activation function, the first reconstructed image is a super-resolution image obtained through reconstruction from a low-resolution image by using a super-resolution network, the high-resolution image and the low-resolution image are training sample images for the super-resolution network, the high-resolution image and the low-resolution image are images of same visual content at different resolutions, the up-sampled image is an image obtained by performing up-sampling on the low-resolution image, and the first reconstructed image, the high-resolution image, and the up-sampled image have a same resolution. The calculation module 142 is configured to perform calculation for a contrastive loss function based on the feature information of the first reconstructed image, the feature information of the high-resolution image, and the feature information of the up-sampled image, which are extracted by the feature extraction module, to obtain a first contrastive loss function value that is based on the first reconstructed image. The adjustment module 143 is configured to adjust a parameter of the super-resolution network based on the first contrastive loss function value obtained by the calculation module, to perform reconstruction from the low-resolution image through the adjusted super-resolution network to obtain a second reconstructed image, where a second contrastive loss function value that is based on the second reconstructed image is less than the first contrastive loss function value.

In some embodiments, the at least one convolution activation module has a same convolutional layer.

In some embodiments, the at least one convolution activation module is connected in series.

In some embodiments, the up-sampling is bicubic interpolation.

In some embodiments, the contrastive loss function is a ratio of a first difference term to a second difference term, where the first difference term is used for representing a difference between the first reconstructed image and the high-resolution image, and the second difference term is used for representing a difference between the up-sampled image and the high-resolution image.

In some embodiments, the first difference term is an L1 distance between the feature information of the first reconstructed image and the feature information of the high-resolution image; and the second difference term is an L1 distance between the feature information of the up-sampled image and the feature information of the high-resolution image.

In some embodiments, the contrastive loss function is a ratio of a third difference term to a fourth difference term, where the third difference term is used for representing a difference between the first reconstructed image and the high-resolution image, and the fourth difference term is used for representing a difference between the first reconstructed image and the up-sampled image.

In some embodiments, the third difference term is an L1 distance between the feature information of the first reconstructed image and the feature information of the high-resolution image; and the fourth difference term is an L1 distance between the feature information of the first reconstructed image and the feature information of the up-sampled image.

In this embodiment of the present disclosure, the modules can implement the super-resolution network parameter adjustment method provided in the above method embodiment, and can achieve the same technical effects. To avoid repetition, details are not described herein again.

An embodiment of the present disclosure further provides an electronic device. FIG. 15 is a schematic diagram of a structure of the electronic device according to an embodiment of the present disclosure. As shown in FIG. 15, the electronic device provided in this embodiment includes a memory 151 and a processor 152, where the memory 151 is configured to store a computer program; and the processor 152 is configured to call the computer program to perform the image super-resolution method and/or the super-resolution network parameter adjustment method provided in the above embodiments.

FIG. 16 is a schematic diagram of a structure of the electronic device according to some other embodiments of the present disclosure, which is used for exemplarily illustrating the electronic device for implementing any super-resolution network parameter adjustment method in the embodiments of the present disclosure and should not be construed as a specific limitation on the embodiments of the present disclosure.

As shown in FIG. 16, the electronic device 160 may include a processor (e.g., a central processor or a graphics processor) 161 that may perform a variety of appropriate actions and processing in accordance with a program stored in a read-only memory (ROM) 162 or a program loaded from a storage apparatus 168 into a random access memory (RAM) 163. The RAM 163 further stores various programs and data required for the operation of the electronic device 160. The processor 161, the ROM 162, and the RAM 163 are connected to each other through a bus 164. An input/output (I/O) interface 165 is also connected to the bus 164.

Generally, the following apparatuses may be connected to the I/O interface 165: an input apparatus 166 including, for example, a touchscreen, a touchpad, a keyboard, a mouse, a camera, a microphone, an accelerometer, and a gyroscope; an output apparatus 167 including, for example, a liquid crystal display (LCD), a speaker, and a vibrator; the storage apparatus 168 including, for example, a tape and a hard disk; and a communication apparatus 169. The communication apparatus 169 may allow the electronic device 160 to perform wireless or wired communication with other devices to exchange data. Although the electronic device 160 having various apparatuses is shown, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 169, installed from the storage apparatus 168, or installed from the ROM 162. When the computer program is executed by the processor 161, the functions defined in any super-resolution network parameter adjustment method provided in the embodiments of the present disclosure may be performed.

An embodiment of the present disclosure further provides a computer-readable storage medium having stored thereon a computer program which, when executed by a processor, causes a computing device to implement the image super-resolution method and/or the super-resolution network parameter adjustment method provided in the above embodiments.

An embodiment of the present disclosure further provides a computer program product, including instructions which, when executed by a processor, cause the processor to implement the image super-resolution method and/or the super-resolution network parameter adjustment method provided in the above embodiments.

An embodiment of the present disclosure further provides a computer program, including instructions which, when executed by a processor, cause the processor to implement the image super-resolution method and/or the super-resolution network parameter adjustment method provided in the above embodiments.

It should be understood by those skilled in the art that the embodiments of the present disclosure can be provided as a method, a system, or a computer program product. Accordingly, the present disclosure may take a form of an entirely hardware embodiment, an entirely software embodiment, or an embodiment combining software and hardware aspects. Furthermore, the present disclosure may take a form of a computer program product implemented on one or more computer-usable storage media that includes computer-usable program code.

The processor may be a central processing unit (CPU), or may be another general-purpose processor, a digital signal processor (DSP), an application-specific integrated circuit (ASIC), a field-programmable gate array (FPGA) or another programmable logic device, a discrete gate or transistor logic device, a discrete hardware component, etc. The general-purpose processor may be a microprocessor, or the processor may be any conventional processor or the like.

The memory may include a form of a non-permanent memory such as a random access memory (RAM) and/or a non-volatile memory such as a read-only memory (ROM) or a flash memory (flash RAM) in computer-readable media. The memory is an example of the computer-readable medium.

The computer-readable media include both permanent and non-permanent, removable and non-removable storage media. The storage medium may implement storage of information by using any method or technology, and the information may be computer-readable instructions, data structures, program modules, or other data. Examples of the computer storage medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, disk storage or other magnetic storage devices, or any other non-transmission media that may be used to store information accessible by a computing device. As defined herein, the computer-readable medium does not include transitory media, such as modulated data signals and carrier waves.

In some implementations, a client and a server may communicate using any currently known or future-developed network protocol such as a Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The present disclosure further provides the following method.

(1) There is provided an image super-resolution method including:
performing, in a super-resolution network, feature extraction on an image to be subjected to super-resolution, to obtain a first image feature;
processing the first image feature through a feature processing module to obtain a second image feature, where the feature processing module includes: a feature refinement unit that includes at least one set of first convolutional layer and first activation function layer that are connected in series and is configured to process an input feature of the feature processing module; a feature fusion unit configured to perform additive fusion on the input feature of the feature processing module and an output feature of the feature refinement unit; and an attention unit configured to process an output feature of the feature fusion unit to obtain an output feature of the feature processing module; and
generating, based on the first image feature and the second image feature, a super-resolution image corresponding to the image to be subjected to super-resolution.

(2) The image super-resolution method according to (1), where the feature processing module further includes a channel quantity adjustment unit, and the channel quantity adjustment unit is configured to adjust the output feature of the feature fusion unit into a feature having a same quantity of channels as the first image feature before the attention unit processes the output feature of the feature fusion unit.

(3) The image super-resolution method according to (2), where the channel quantity adjustment unit includes a second convolutional layer, where the second convolutional layer has a convolution kernel size of 1*1.

(4) The image super-resolution method according to any one of (1) to (3), where the processing the first image feature through a feature processing module to obtain a second image feature includes: processing the first image feature through a plurality of stages of feature processing modules that are connected in series, to obtain the second image feature.

(5) The image super-resolution method according to any one of (1) to (4), where an activation function at the first activation function layer is a linear rectification function ReLU.

(6) The image super-resolution method according to any one of (1) to (5), where the performing feature extraction on an image to be subjected to super-resolution, to obtain a first image feature includes: processing, through a third convolutional layer, the image to be subjected to super-resolution, to obtain the first image feature.

(7) The image super-resolution method according to any one of (1) to (6), where the generating, based on the first image feature and the second image feature, a super-resolution image corresponding to the image to be subjected to super-resolution includes:
processing the second image feature through a fourth convolutional layer to obtain a third image feature; performing additive fusion on the first image feature and the third image feature to obtain a fourth image feature; processing the fourth image feature through a fifth convolutional layer to obtain a fifth image feature; up-sampling the fifth image feature to obtain a sixth image feature; and
generating, based on the sixth image feature, the super-resolution image corresponding to the image to be subjected to super-resolution.

(8) The image super-resolution method according to any one of (1) to (7), further including: separately extracting feature information of a first reconstructed image, feature information of a high-resolution image, and feature information of an up-sampled image through a feature extractor, where the feature extractor includes at least one convolution activation module, the convolution activation module includes a convolutional layer and an activation function, the first reconstructed image is a super-resolution image obtained through reconstruction from a low-resolution image by using the super-resolution network, the high-resolution image and the low-resolution image are training sample images for the super-resolution network, the high-resolution image and the low-resolution image are images of same visual content at different resolutions, the up-sampled image is an image obtained by performing up-sampling on the low-resolution image, and the first reconstructed image, the high-resolution image, and the up-sampled image have a same resolution;
performing calculation for a contrastive loss function based on the feature information of the first reconstructed image, the feature information of the high-resolution image, and the feature information of the up-sampled image to obtain a first contrastive loss function value that is based on the first reconstructed image; and
adjusting a parameter of the super-resolution network based on the first contrastive loss function value, to perform reconstruction from the low-resolution image through the adjusted super-resolution network to obtain a second reconstructed image, where a second contrastive loss function value that is based on the second reconstructed image is less than the first contrastive loss function value.

(9) The image super-resolution method according to (8), where the at least one convolution activation module has a same convolutional layer.

(10) The image super-resolution method according to (9), where the at least one convolution activation module is connected in series.

(11) The image super-resolution method according to any one of (8) to (10), where the up-sampling is bicubic interpolation.

(12) The image super-resolution method according to any one of (8) to (11), where the contrastive loss function is a ratio of a first difference term to a second difference term, where the first difference term is used for representing a difference between the first reconstructed image and the high-resolution image, and the second difference term is used for representing a difference between the up-sampled image and the high-resolution image.

(13) The image super-resolution method according to (12), where the first difference term is an L1 distance between the feature information of the first reconstructed image and the feature information of the high-resolution image; and
the second difference term is an L1 distance between the feature information of the up-sampled image and the feature information of the high-resolution image.

(14) The image super-resolution method according to any one of (8) to (13), where the contrastive loss function is a ratio of a third difference term to a fourth difference term, where the third difference term is used for representing a difference between the first reconstructed image and the high-resolution image, and the fourth difference term is used for representing a difference between the first reconstructed image and the up-sampled image.

(15) The image super-resolution method according to (14), where the third difference term is an L1 distance between the feature information of the first reconstructed image and the feature information of the high-resolution image; and the fourth difference term is an L1 distance between the feature information of the first reconstructed image and the feature information of the up-sampled image.

The present disclosure further provides the following apparatus.

(16) There is provided an image super-resolution apparatus including:
a feature extraction component configured to perform, in a super-resolution network, feature extraction on an image to be subjected to super-resolution, to obtain a first image feature;
a feature processing component configured to process the first image feature through a feature processing module to obtain a second image feature, where the feature processing module includes: a feature refinement unit that includes at least one set of first convolutional layer and first activation function layer that are connected in series and is configured to process an input feature of the feature processing module; a feature fusion unit configured to perform additive fusion on the input feature of the feature processing module and an output feature of the feature refinement unit; and an attention unit configured to process an output feature of the feature fusion unit to obtain an output feature of the feature processing module; and
an image reconstruction component configured to generate, based on the first image feature and the second image feature, a super-resolution image corresponding to the image to be subjected to super-resolution.

(17) The image super-resolution apparatus according to (16), further including a feature extraction module, a calculation module, and an adjustment module.

The feature extraction module is configured to separately extract feature information of a first reconstructed image, feature information of a high-resolution image, and feature information of an up-sampled image through a feature extractor, where the feature extractor includes at least one convolution activation module, the convolution activation module includes a convolutional layer and an activation function, the first reconstructed image is a super-resolution image obtained through reconstruction from a low-resolution image by using the super-resolution network, the high-resolution image and the low-resolution image are training sample images for the super-resolution network, the high-resolution image and the low-resolution image are images of same visual content at different resolutions, the up-sampled image is an image obtained by performing up-sampling on the low-resolution image, and the first reconstructed image, the high-resolution image, and the up-sampled image have a same resolution.

The calculation module is configured to perform calculation for a contrastive loss function based on the feature information of the first reconstructed image, the feature information of the high-resolution image, and the feature information of the up-sampled image, which are extracted by the feature extraction module, to obtain a first contrastive loss function value that is based on the first reconstructed image.

The adjustment module is configured to adjust a parameter of the super-resolution network based on the first contrastive loss function value obtained by the calculation module, to perform reconstruction from the low-resolution image through the adjusted super-resolution network to obtain a second reconstructed image, where a second contrastive loss function value that is based on the second reconstructed image is less than the first contrastive loss function value.

(18) There is provided an electronic device, including a memory and a processor, where the memory is configured to store a computer program; and the processor is configured to run the computer program to perform the image super-resolution method according to any one of (1) to (15).

(19) There is provided a computer-readable storage medium having stored thereon a computer program which is executed by a processor to perform the image super-resolution method according to any one of (1) to (15).

(20) There is provided a computer program product having stored thereon a computer program which is executed by a processor to perform the image super-resolution method according to any one of (1) to (15).

(21) There is provided a computer program, including instructions which are executed by a processor to perform the image super-resolution method according to any one of (1) to (15). It should be finally noted that the above embodiments are merely for describing rather than limiting the technical solutions of the present disclosure. Although the present disclosure has been illustrated in detail with reference to the foregoing embodiments, it should be understood by those of ordinary skill in the art that modifications may still be made to the technical solutions described in the foregoing embodiments, or equivalent replacements may be made to all or a part of the technical features; and these modifications or replacements will not cause the essence of corresponding technical solutions to depart from the scope of the technical solutions in the embodiments of the present disclosure.

1. An image super-resolution method, comprising:
performing feature extraction on an image to be subjected to super-resolution, to obtain a first image feature;
processing the first image feature through a feature processing module to obtain a second image feature, wherein the feature processing module comprises: a feature refinement unit that comprises at least one set of first convolutional layer and first activation function layer that are connected in series and is configured to process an input feature of the feature processing module; a feature fusion unit configured to perform additive fusion on the input feature of the feature processing module and an output feature of the feature refinement unit; and an attention unit configured to process an output feature of the feature fusion unit to obtain an output feature of the feature processing module; and
generating, based on the first image feature and the second image feature, a super-resolution image corresponding to the image to be subjected to super-resolution.

2. The image super-resolution method according to claim 1, wherein the feature processing module further comprises a channel quantity adjustment unit, and the channel quantity adjustment unit is configured to adjust the output feature of the feature fusion unit into a feature having a same quantity of channels as the first image feature before the attention unit processes the output feature of the feature fusion unit.

3. The image super-resolution method according to claim 2, wherein the channel quantity adjustment unit comprises a second convolutional layer, wherein the second convolutional layer has a convolution kernel size of 1*1.

4. The image super-resolution method according to claim 1, wherein the processing the first image feature through the feature processing module to obtain the second image feature comprises:
processing the first image feature through a plurality of stages of feature processing modules that are connected in series, to obtain the second image feature.

5. The image super-resolution method according to claim 1, wherein an activation function at the first activation function layer is a linear rectification function ReLU.

6. The image super-resolution method according to claim 1, wherein the performing feature extraction on the image to be subjected to super-resolution, to obtain the first image feature comprises:
processing, through a third convolutional layer, the image to be subjected to super-resolution, to obtain the first image feature.

7. The image super-resolution method according to claim 1, wherein the generating, based on the first image feature and the second image feature, the super-resolution image corresponding to the image to be subjected to super-resolution comprises:
processing the second image feature through a fourth convolutional layer to obtain a third image feature;
performing additive fusion on the first image feature and the third image feature to obtain a fourth image feature;
processing the fourth image feature through a fifth convolutional layer to obtain a fifth image feature;
up-sampling the fifth image feature to obtain a sixth image feature; and
generating, based on the sixth image feature, the super-resolution image corresponding to the image to be subjected to super-resolution.

8. A super-resolution network parameter adjustment method, comprising:
separately extracting feature information of a first reconstructed image, feature information of a high-resolution image, and feature information of an up-sampled image through a feature extractor, wherein the feature extractor comprises at least one convolution activation module, the convolution activation module comprises a convolutional layer and an activation function, the first reconstructed image is a super-resolution image obtained through reconstruction from a low-resolution image by using a super-resolution network, the high-resolution image and the low-resolution image are training sample images for the super-resolution network, the high-resolution image and the low-resolution image are images of same visual content at different resolutions, the up-sampled image is an image obtained by performing up-sampling on the low-resolution image, and the first reconstructed image, the high-resolution image, and the up-sampled image have a same resolution;
performing calculation for a contrastive loss function based on the feature information of the first reconstructed image, the feature information of the high-resolution image, and the feature information of the up-sampled image to obtain a first contrastive loss function value that is based on the first reconstructed image; and
adjusting a parameter of the super-resolution network based on the first contrastive loss function value, to perform reconstruction from the low-resolution image through the adjusted super-resolution network to obtain a second reconstructed image, wherein a second contrastive loss function value that is based on the second reconstructed image is less than the first contrastive loss function value.

9. The super-resolution network parameter adjustment method according to claim 8, wherein the at least one convolution activation module has a same convolutional layer.

10. The super-resolution network parameter adjustment method according to claim 9, wherein the at least one convolution activation module is connected in series.

11. The super-resolution network parameter adjustment method according to claim 8, wherein the up-sampling is bicubic interpolation.

12. The super-resolution network parameter adjustment method according to claim 8, wherein the contrastive loss function is a ratio of a first difference term to a second difference term, wherein the first difference term is used for representing a difference between the first reconstructed image and the high-resolution image, and the second difference term is used for representing a difference between the up-sampled image and the high-resolution image.

13. The super-resolution network parameter adjustment method according to claim 12, wherein the first difference term is an L1 distance between the feature information of the first reconstructed image and the feature information of the high-resolution image; and
the second difference term is an L1 distance between the feature information of the up-sampled image and the feature information of the high-resolution image.

14. The super-resolution network parameter adjustment method according to claim 8, wherein the contrastive loss function is a ratio of a third difference term to a fourth difference term, wherein the third difference term is used for representing a difference between the first reconstructed image and the high-resolution image, and the fourth difference term is used for representing a difference between the first reconstructed image and the up-sampled image.

15. The super-resolution network parameter adjustment method according to claim 14, wherein the third difference term is an L1 distance between the feature information of the first reconstructed image and the feature information of the high-resolution image; and
the fourth difference term is an L1 distance between the feature information of the first reconstructed image and the feature information of the up-sampled image.

16.-17. (canceled)

18. An electronic device, comprising a memory and a processor, wherein the memory is configured to store a computer program; and the processor is configured to call the computer program to perform the image super-resolution method according to claim 1.

19. A non-transitory computer-readable storage medium having stored thereon a computer program which, when executed by a processor, implements the following image super-resolution operations:
performing feature extraction on an image to be subjected to super-resolution, to obtain a first image feature;
processing the first image feature through a feature processing module to obtain a second image feature, wherein the feature processing module comprises: a feature refinement unit that comprises at least one set of first convolutional layer and first activation function layer that are connected in series and is configured to process an input feature of the feature processing module; a feature fusion unit configured to perform additive fusion on the input feature of the feature processing module and an output feature of the feature refinement unit; and an attention unit configured to process an output feature of the feature fusion unit to obtain an output feature of the feature processing module; and
generating, based on the first image feature and the second image feature, a super-resolution image corresponding to the image to be subjected to super-resolution.

20. (canceled)

21. The computer-readable storage medium according to claim 19, wherein the feature processing module further comprises a channel quantity adjustment unit, and the channel quantity adjustment unit is configured to adjust the output feature of the feature fusion unit into a feature having a same quantity of channels as the first image feature before the attention unit processes the output feature of the feature fusion unit.

22. An electronic device, comprising a memory and a processor, wherein the memory is configured to store a computer program; and the processor is configured to call the computer program to perform the super-resolution network parameter adjustment method according to claim 8.

23. A non-transitory computer-readable storage medium having stored thereon a computer program which, when executed by a processor, implements the super-resolution network parameter adjustment method according to claim 8.
